(19) United States
(12) Patent Application Publication
(10) Pub. No.: US 2008/0007963 A1
(43) Pub. Date: Jan. 10, 2008

(54) Liquid Crystal Display and Backlight Module Thereof

(75) Inventor: Hung-Sheng Hsieh, Tainan County (TW)

Correspondence Address: THOMAS, KAYDEN, HORSTEMEYER & RISLEY, LLP, 600 GALLERIA PARKWAY, STE 1500, ATLANTA, GA, 30339, US

(73) Assignee: CHI MEI OPTOELECTRONICS CORP., Tainan County (TW)

(21) Appl. No.: 11/773,493

(22) Filed: Jul. 5, 2007

(30) Foreign Application Priority Data
Jul. 7, 2006 (TW) 95124641

(51) Int. Cl. F21V 7/04

(52) U.S. Cl. 362/600; 362/608; 362/607; 362/612

(57) ABSTRACT

A liquid crystal display and a backlight module thereof are provided. The liquid crystal display includes a liquid crystal display panel and the backlight module disposed under the panel. The backlight module includes an optical plate, at least a metal plate, a circuit board, a plurality of light emitting devices and a heat conductor. The optical plate has a light incident surface and a light exit surface. The light exit surface faces the liquid crystal display panel. The metal plate and the circuit board are disposed near the light incident surface. The light emitting devices are disposed between the metal plate and the light incident surface. The heat conductor is disposed between the light emitting devices and the metal plate, for conducting heat generated by the light emitting devices to the metal plate.

This application claims the benefit of Taiwan application Serial No. 095124641, filed Jul. 7, 2006, the subject matter of which is incorporated herein by reference.

### BACKGROUND OF THE INVENTION

1. Field of the Invention

The invention relates in general to a display and a backlight module thereof, and more particularly to a liquid crystal display and a backlight module thereof.

2. Description of the Related Art

As the computer performance greatly progresses and the multimedia technology highly develops, most of the image information is transmitted through digital transmission instead of analog transmission. For matching the modern life style, the volume of video devices has become more and more compact. The flat panel display (FPD), such as the liquid crystal display (LCD), the organic light-emitting diode (OLED) or the plasma display panel (PDP), is developed corresponding to the optoelectronic technology and the semiconductor manufacturing technology. The flat panel display has gradually become the main trend of the display products. As to the liquid crystal display, the liquid crystal display panel is not self-luminous. Therefore, the liquid crystal display panel needs a backlight module to provide a surface light source for displaying images.

FIG. 1 is a cross-sectional view of a portion of a conventional edge-type backlight module. Please referring to FIG. 1, the conventional backlight module 100 includes a circuit board 112, a plurality of light emitting diodes (LED) 114, a light guide plate 120 and a back plate 130. The circuit board 112, the light emitting diodes 114 and the light guide plate 120 are disposed in the back plate 130. The circuit board 112 and the light emitting diodes 114 are disposed near a light incident surface 122 of the light guide plate 120. The light emitting diodes 114 are disposed on the circuit board 112. However, as the requirement of the liquid crystal display for brightness increases, larger current is used for driving the light emitting diodes 114 in order to achieve higher brightness. In the conventional design, heat generated by the light emitting diodes 114 during operation is dissipated only through pins. Therefore, when the driving current increases, heat cannot be dissipated efficiently. Furthermore, when the temperature of the light emitting diodes 114 increases due to poor heat dissipation, the luminescence efficiency is lowered.

For solving the problem that heat is not dissipated efficiently when the driving current is large and for satisfying the requirement of the liquid crystal display for brightness, the number of the light emitting diodes 114 is increased conventionally. When the number of the light emitting diodes 114 is increased, the backlight module provides enough brightness without increasing driving current. However, the cost is increased significantly. Therefore, it is very important to increase the brightness of the backlight module without increasing the cost.

### SUMMARY OF THE INVENTION

The invention is directed to a backlight module with better heat dissipation efficiency.

The invention is directed to a liquid crystal display including a backlight module with better heat dissipation efficiency.

According to the present invention, a backlight module is provided. The backlight module includes an optical plate, at least a metal plate, a plurality of light emitting devices, a circuit board and a heat conductor. The optical plate has a light incident surface and a light exit surface. The metal plate is disposed near the light incident surface of the optical plate. The light emitting devices are disposed between the metal plate and the light incident surface. The circuit board is electrically connected with the light emitting devices. The heat conductor is disposed between the light emitting devices and the metal plate for conducting heat generated by the light emitting devices to the metal plate.

According to the present invention, a liquid crystal display including a liquid crystal display panel and a backlight module disposed under the panel is provided. The backlight module includes an optical plate, at least a metal plate, a plurality of light emitting device, a circuit board and a heat conductor. The optical plate has a light incident surface and a light exit surface. The metal plate is disposed near the light incident surface of the optical plate. The light emitting devices are disposed between the metal plate and the light incident surface. The circuit board is electrically connected with the light emitting devices. The heat conductor is disposed between the light emitting devices and the metal plate for conducting heat generated by the light emitting devices to the metal plate.

In an embodiment of the backlight module and the liquid crystal display described above, each light emitting device includes a plurality of pins for example. The heat conductor can be made of an electrically insulating material. For example, the heat conductor is disposed on the pins, spanning the edge of the circuit board and contacts the metal plate. Furthermore, the metal plate can be a back plate or a reflection plate or any metal material. The heat conductor can be an electrically insulating thermally conductive adhesive.

In another embodiment of the backlight module and the liquid crystal display described above, the circuit board is disposed between the light emitting devices and the metal plate and has at least a hollow area for example. Each light emitting device preferably includes a plurality of pins, and the heat conductor can be made of an insulating material. For example, the heat conductor is disposed in the hollow area and contacts the pins and the metal plate in the hollow area. Furthermore, the metal plate can be a back plate or a reflection plate or any metal material. The heat conductor can be an electrically insulating thermally conductive adhesive or a metal block.

In another embodiment of the backlight module and the liquid crystal display described above, the circuit board includes at least a hollow area. For example, each light emitting device includes a chip, and the heat conductor is disposed in the hollow area and contacts the chip and the metal plate in the hollow area. Furthermore, the metal plate can be a back plate or a reflection plate or any metal material. The optical plate, the reflection plate, the circuit board and the light emitting devices are disposed on the back plate. Furthermore, the heat conductor can be an electrically insulating thermally conductive adhesive or a metal block.

In another embodiment of the backlight module and the liquid crystal display described above, the backlight module further includes an electrically insulating thermally conductive material for example. The circuit board includes at least a hollow area. Each light emitting device includes a chip and a plurality of pins near the chip for example. The heat conductor is preferably disposed in the hollow area and contacts the chip and the metal plate in the hollow area. The electrically insulating thermally conductive material can be disposed on the pins, spanning the edge of the circuit board and contacts the metal plate. Furthermore, the metal plate is a back plate or a reflection plate for example or any metal material. The reflection plate, the metal plate, the circuit board and the light emitting devices are disposed on the back plate. Moreover, the heat conductor can be an electrically insulating thermally conductive adhesive or a metal block.

In another embodiment of the backlight module and the liquid crystal display described above, the reflection plate is disposed near the light emitting devices. Each light emitting device includes a plurality of pins for example. The heat conductor is preferably made of an insulating material. The heat conductor can be disposed between the pins and the metal plate. Furthermore, the metal plate is a back plate or a reflection plate or any metal material. The optical plate, the metal plate, the circuit board and the light emitting devices are disposed on the back plate. Furthermore, the heat conductor can be an electrically insulating thermally conductive adhesive or a metal block.

In another embodiment of the backlight module and the liquid crystal display described above, the backlight module further includes an electrically insulating thermally conductive material and a reflection plate. The circuit board includes at least a hollow area. The reflection plate is disposed near the light emitting devices. Each light emitting device includes a chip and a plurality of pins near the chip for example. The heat conductor is preferably disposed in the hollow area and contacts the chip and the metal plate in the hollow area. The electrically insulating thermally conductive material can be disposed between the pins and the reflection plate. Furthermore, the metal plate is a back plate, and the heat conductor can be an electrically insulating thermally conductive adhesive or a metal block.

In another embodiment of the backlight module and the liquid crystal display described above, the circuit board is disposed between the light emitting devices and the metal plate for example. The circuit board is preferably a multi-layer board and includes a core metal layer. An upper surface and a lower surface of the circuit board has an opening respectively. The opening exposes a portion of the core metal layer. The heat conductor is preferably disposed in the opening. Heat generated by the light emitting devices is conducted to the metal plate through the core metal layer and the heat conductor disposed in the opening. Furthermore, the metal plate can be a back plate or a reflection plate or any metal material. The heat conductor can be an electrically insulating thermally conductive adhesive.

In the backlight module and the liquid crystal display described above, the light emitting devise are preferably arranged in a row and have a plurality of pins respectively. The pins are disposed on two sides of the row of the light emitting devices.

In the backlight module and the liquid crystal display described above, the light emitting device can be light emitting diodes.

In the backlight module and the liquid crystal display described above, the light incident surface is preferably perpendicular or parallel to the light exit surface.

In the backlight module and the liquid crystal display described above, the light emitting device are arranged in an array.

As stated above, in the liquid crystal display and the backlight module thereof, heat generated by the light emitting devices is conducted to the adjacent metal plate through the heat conductor. Therefore, the liquid crystal display and the backlight module thereof of the present invention have better heat dissipation efficiency. Larger current can be used for driving the light emitting devices, so that greater brightness is achieved with good heat dissipation efficiency. Also, the number of the light emitting devices can be reduced because each light emitting device provides greater brightness. As a result, the manufacturing cost of the liquid crystal display and the backlight module thereof is lowered.

The invention will become apparent from the following detailed description of the preferred but non-limiting embodiments. The following description is made with reference to the accompanying drawings.

### BRIEF DESCRIPTION OF THE DRAWINGS

FIG. 1 is a cross-sectional view of a portion of a conventional edge-type backlight module;

FIG. 2 is a cross-sectional view of a portion of a backlight module according to a first embodiment of the present invention;

FIG. 3 illustrates the arrangement of light emitting devices in FIG. 2;

FIG. 4 is a cross-sectional view of the backlight module according to a second embodiment of the present invention;

FIG. 5 is a cross-sectional view of a portion of the backlight module according to a third embodiment of the present invention;

FIG. 6 is a cross-sectional view of a portion of the backlight module according to a fourth embodiment of the present invention;

FIG. 7 is a cross-sectional view of a portion of the backlight module according to a fifth embodiment of the present invention;

FIG. 8 is a cross-sectional view of a portion of the backlight module according a sixth embodiment of the present invention;

FIG. 9 is a cross-sectional view of a portion the backlight module according to a seventh embodiment of the present invention;

FIG. 10 is a cross-sectional view of a portion of the backlight module according to an eighth embodiment of the present invention;

FIG. 11 is a cross-sectional view of a portion of the backlight module according to a ninth embodiment of the present invention;

FIG. 12 is a cross-sectional view of the backlight module according to a tenth embodiment of the present invention; and

FIG. 13 illustrates a liquid crystal display according to an embodiment of the present invention.

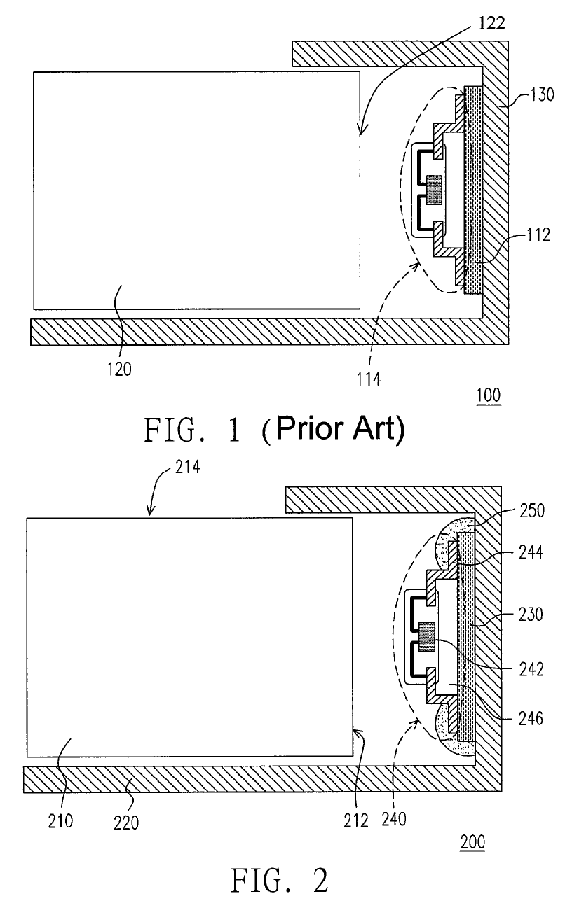

### DETAILED DESCRIPTION OF THE INVENTION

In the backlight module of the present invention, a heat conductor is disposed between light emitting devices and a metal plate. Therefore, heat conducting paths of the light emitting devices are increased for achieving better heat dissipation efficiency. The backlight module of the present invention can be an edge-type, direct-type or another type of backlight module.

### First Embodiment

FIG. 2 is a cross-sectional view of a portion of a backlight module according to a first embodiment of the present invention. Please referring to FIG. 2, the backlight module 200 of the present embodiment includes an optical plate 210, at least a metal plate 220, a circuit board 230, a plurality of light emitting devices 240 and a heat conductor 250. The optical plate 210 has a light incident surface 212 and a light exit surface 214. More specifically speaking, the optical plate 210 can be a light guide plate used in an edge-type backlight module, a diffusion plate used in a direct-type backlight module or another type of optical plate. As long as the optical plate 210 is able to transform the light provided by the light emitting device 240 into a surface light source, the present invention encompasses such modification. In other words, the light incident surface 212 can be perpendicular to or parallel to the light exit surface 214. In the present embodiment, the light incident surface 212 is perpendicular to the light exit surface 214 as an example.

The metal plate 220 and the circuit board 230 are disposed near the light incident surface 212 of the optical plate 210. In the present embodiment, the metal plate 220 is a back plate for carrying other components of the backlight module 200 or a reflection plate. The light emitting devices 240 are disposed between the metal plate 220 and the light incident surface 212. The circuit board 230 is electrically connected with the light emitting devices 240. Only one light emitting device 240 is illustrated in FIG. 2. However, the backlight module 200 includes a plurality of light emitting devices 240. Furthermore, the light emitting devices 240 can be light emitting diodes (LED) or other point light sources. The light emitting device 240 includes a chip 242, a plurality of pins 244 and a molding compound 246. The pins 244 are electrically connected with the chip 242 for providing the current to drive the chip 242 to emit light. The molding compound 246 is for protecting the electrical connection between the chip 242 and the pins 244. The heat conductor 250 is disposed between the light emitting devices 240 and the metal plate 220. Therefore, heat generated by the light emitting devices 240 during operation is conducted to the metal plate 220 through the heat conductor 250 for dissipating heat. As a result, large current can be used for driving the light emitting devices 240 and achieving greater brightness. Meanwhile, the number of the light emitting devices 240 can be reduced for lowering the manufacturing cost of the entire apparatus.

In the present embodiment, the circuit board 230 is disposed between the light emitting devices 240 and the metal plate 220. The heat conductor 250 is preferably an insulating material, such as an electrically insulating thermally conductive adhesive. The heat conductor 250 is disposed on the pins 244, spans the edge of the circuit board 230 and contacts the metal plate 220. As a result, heat is conducted from the pins 244 to the metal plate 220. The heat conductor 250 of the present embodiment is made of an insulating material. Therefore, even when contacting a plurality of pins 244 at the same time, the heat conductor 250 does not cause short circuits of the pins 244.

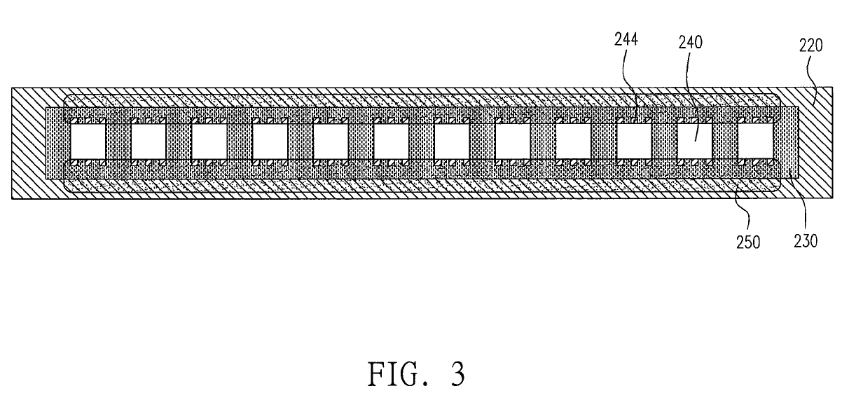

Furthermore, the light emitting devices 240 are for example arranged in a row, and the pins 244 are disposed on two sides of the light emitting devices 240, as shown in FIG. 3. Therefore, a heat conductor 250 can be adhered or coated parallel to the light emitting devices 240 arranged direction because all the pins 244 are located linearly on two sides of the light emitting devices 240. The assembly time is reduced, and the yield rate is increased.

### Second Embodiment

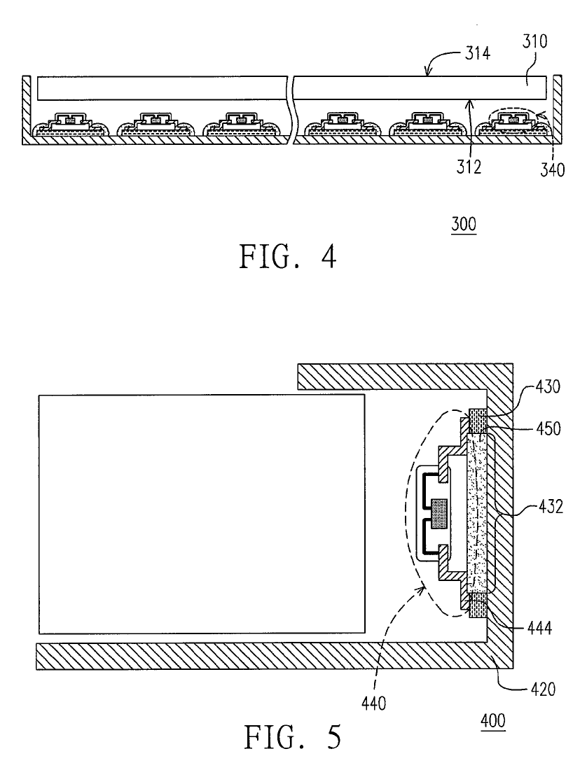

FIG. 4 is a cross-sectional view of the backlight module according to a second embodiment of the present invention. Please refer to FIG. 4. The difference between the backlight module 300 of the present embodiment and the backlight module 200 of the first embodiment is that the backlight module 300 is a direct-type backlight module. In other words, the light incident surface 312 of the optical plate 310 is parallel to the light exit surface 314. The light emitting devices 340 are arranged in an array near the light incident surface 312 and under the optical plate 310. Furthermore, the optical plate 310 is a diffusion plate used in a direct-type backlight module. Of course, the backlight module in all kinds of embodiments of the present invention can be direct-type or edge-type, and the description thereof is not described repeatedly. Moreover, other components of the backlight module 300 are similar to those of the backlight module 200 in FIG. 2 and not described repeatedly as well.

### Third Embodiment

FIG. 5 is a cross-sectional view of a portion of the backlight module according to a third embodiment of the present invention. Please refer to FIG. 5. The difference between the backlight module 400 of the present embodiment and the backlight module 200 of the first embodiment is illustrated as follow. The circuit board 430 has at least one hollow area 432. For example, the hollow area 432 is a long strip. Each light emitting device 440 is disposed over the hollow area 432. The pins 444 of the light emitting device 440 are connected with the circuit board 430. Or, one independent hollow area 432 is under each light emitting device 440. The pins 444 of the light emitting device 440 are connected with the circuit board 430. Furthermore, the heat conductor is disposed in the hollow area 432 and contacts the pins 444 and the metal plate 420 in the hollow area 432. Other components of the backlight module 400 are similar to those of the backlight module 200 in FIG. 2 and not described repeatedly.

### Fourth Embodiment

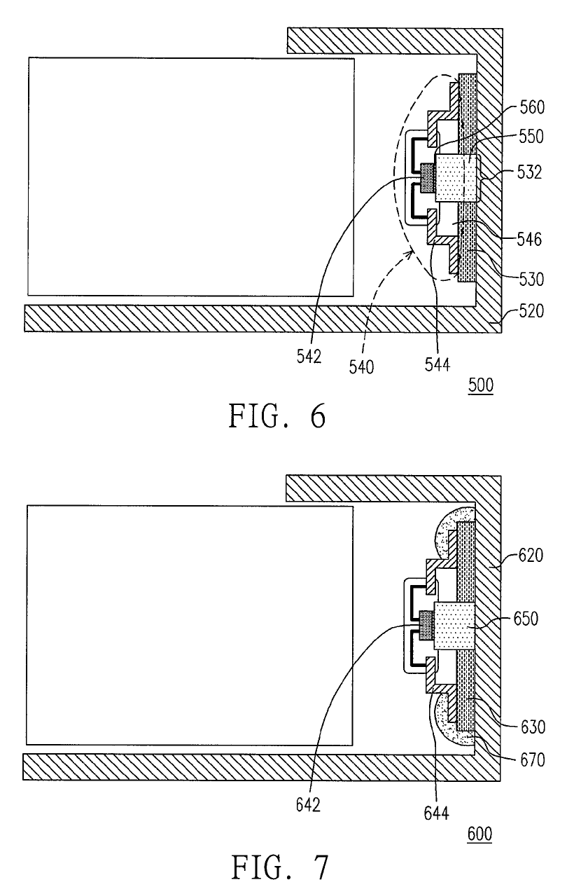

FIG. 6 is a cross-sectional view of a portion of the backlight module according to a fourth embodiment of the present invention. Please refer to FIG. 6. The difference between the backlight module 500 of the present embodiment and the backlight module 400 of the third embodiment is illustrated as follow. The back surface of the chip 542 of the light emitting device 540 is exposed to the surroundings and not encapsulated by the molding compound 546. The heat conductor 550 is disposed in the hollow area 532 of the circuit board 530 and contacts the chip 542 and the metal plate 520 in the hollow area 532. Therefore, the heat conductor 550 is able to directly conduct heat from the back surface of the chip 542 to the metal plate 520. Moreover, the heat conductor 550 of the present embodiment is preferably made of metal or another suitable material. When the heat conductor 550 is a metal block, a heat sink compound 560 is preferably disposed between the heat conductor 550 and the chip 542 for providing a best heat conduction path between the heat conductor 550 and the chip 542. Other components of the backlight module 500 are similar to those of the backlight module 400 in FIG. 5 and not described repeatedly.

### Fifth Embodiment

FIG. 7 is a cross-sectional view of a portion of the backlight module according to a fifth embodiment of the present invention. Please refer to FIG. 7. The difference between the backlight module 600 of the present embodiment and the backlight module 500 of the fourth embodiment is illustrated as follow. The backlight module 600 further includes an electrically insulating thermally conductive material 670 disposed on the pins 644, spanning the edge of the circuit board 630 and contacting the metal plate 620. In the backlight module 600, heat is not only conducted from the back surface of the chip 642 to the metal plate 620 through the heat conductor 650, but also conducted from the pins 644 to the metal plate 620 through the electrically insulating thermally conductive material 670. Other components of the backlight module 600 are similar to those of the backlight module 500 in FIG. 6 and not described repeatedly.

### Sixth Embodiment

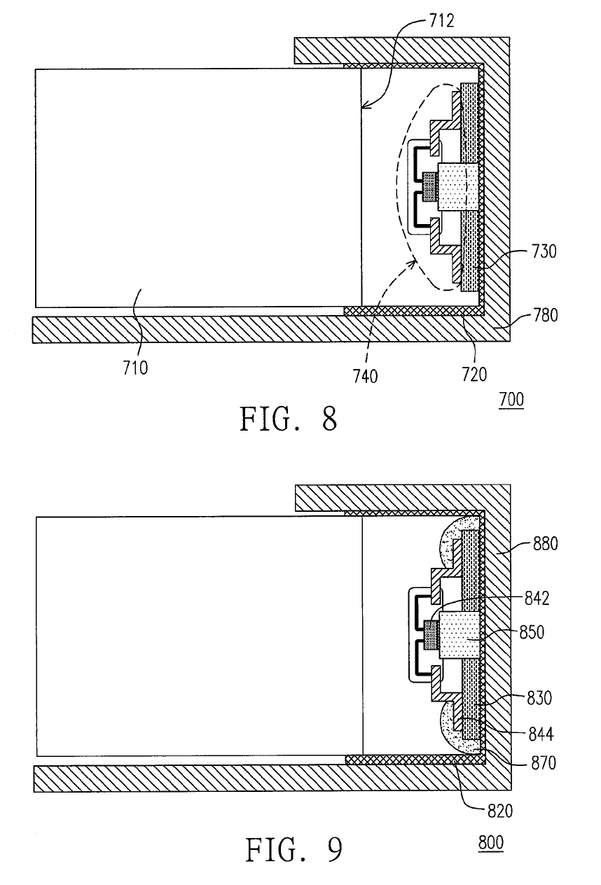

FIG. 8 is a cross-sectional view of a portion of the backlight module according a sixth embodiment of the present invention. Please refer to FIG. 8. The difference between the backlight module 700 of the present embodiment and the backlight module 500 of the fourth embodiment is illustrated as follow. The present embodiment includes a reflection plate 720, and the backlight module 700 further includes a metal plate 780. The optical plate 710, the reflection plate 720, the circuit board 730 and the light emitting device 740 are disposed on the metal plate 780. The circuit board 730 and the light emitting devices 740 are disposed between the metal plate 780 and the light incident surface 712. Due to the disposition of the reflection plate 720, most of the light emitted by the light emitting devices 740 enters the optical plate 710 through the light incident surface 712. Furthermore, the metal plate 780 is preferably a back plate. Other components of the backlight module 700 are similar to those of the backlight module 500 in FGI. 6 and not described repeatedly.

### Seventh Embodiment

FIG. 9 is a cross-sectional view of a portion the backlight module according to a seventh embodiment of the present invention. Please refer to FIG. 9. The difference between the backlight module 800 of the present embodiment and the backlight module 700 of the sixth embodiment is illustrated as follow. The backlight module 800 further includes an electrically insulating thermally conductive material 870 disposed on the pins 844, spanning the edge of the circuit board 830 and contacting the reflection plate 820. In other words, in the backlight module 800, heat is conducted from the back surface of the chip 842 to the reflection plate 820 through the heat conductor 850. Also, heat is conducted from the pins 844 to the reflection plate 820 through the electrically insulating thermally conductive material 870 and then to the metal plate 880. Moreover, the metal plate 880 is preferably a back plate. Other components of the backlight module 800 are similar to those of the backlight module 700 in FIG. 8 and not described repeatedly.

### Eighth Embodiment

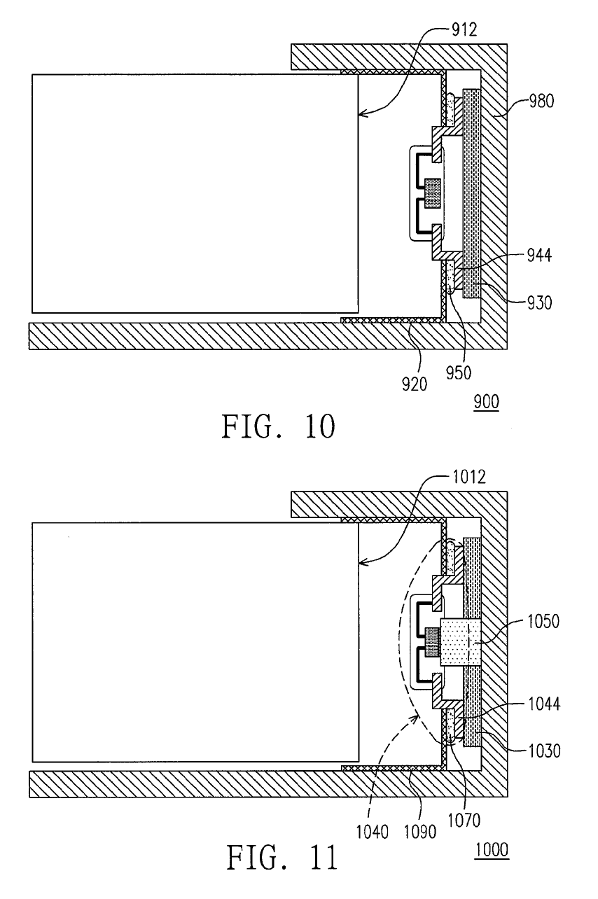

FIG. 10 is a cross-sectional view of a portion of the backlight module according to an eighth embodiment of the present invention. Please refer to FIG. 10. The difference between the backlight module 900 of the present embodiment and the backlight module 200 of the first embodiment is illustrated as follow. In the present embodiment, the reflection plate 920 is disposed between the light incident surface 912 and the circuit board 930, and near the light emitting devices 940. The heat conductor 950 is disposed between the pins 944 and the reflection plate 920. Furthermore, preferably the back light module 900 further includes a metal plate 980 which is similar to the metal plate 780 in FIG. 8. Moreover, the reflection plate 920 is preferably a single plate with an opening for exposing the light emitting device 940. Or, the reflection plate 920 includes a plurality of plates which are disposed without blocking the light emitted by the light emitting devices 940 from entering the light incident surface 912. Besides, the metal plate 980 is preferably a back plate. Other components of the backlight module 900 are similar to those of the backlight module 200 in FIG. 2 and not described repeatedly.

### Ninth Embodiment

FIG. 11 is a cross-sectional view of a portion of the backlight module according to a ninth embodiment of the present invention. Please refer to FIG. 11. The difference between the backlight module 1000 of the present embodiment and the backlight module 500 of the fourth embodiment is illustrated as follow. The backlight module 1000 further includes an electrically insulating thermally conductive material 1070 and a reflection plate 1090. The reflection plate 1090 is disposed between the light incident surface 1012 and the circuit board 1030 and near the light emitting devices 1040. The electrically insulating thermally conductive material 1070 is disposed between the pins 1044 and the reflection plate 1090. Other components of the backlight module 1000 are similar to those of the backlight module 500 in FIG. 6 and not described repeatedly.

### Tenth Embodiment

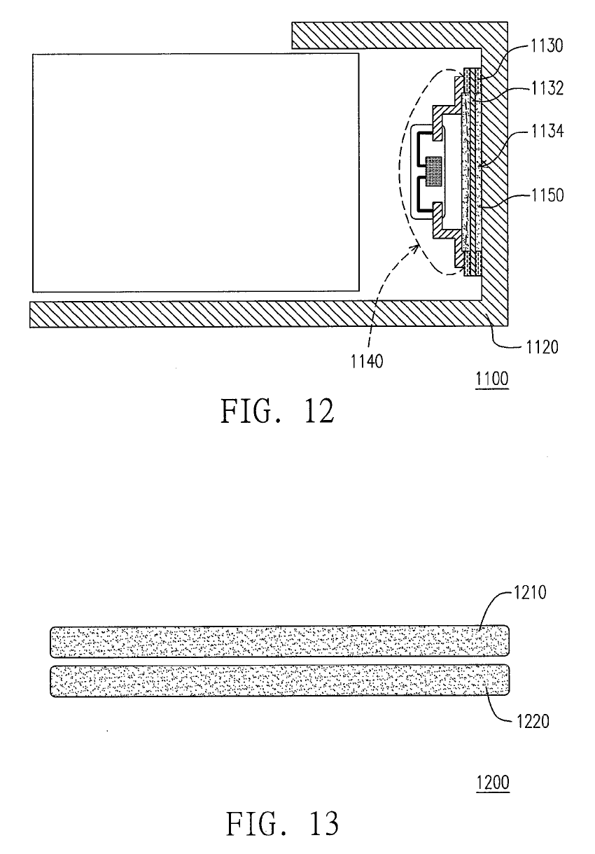

FIG. 12 is a cross-sectional view of the backlight module according to a tenth embodiment of the present invention. Please refer to FIG. 12. The difference between the backlight module 1100 of the present embodiment and the backlight module 400 of the third embodiment is illustrated as follow. For example, the circuit board 1130 is a multi-layer board and has a core metal layer 1132. Furthermore, an upper surface and a lower surface of the circuit board 110 have an opening 1134 respectively. The opening 1134 exposes a portion of the core metal layer 1132. The heat conductor 1150 is disposed in the opening. Therefore, heat generated by the light emitting device 1140 is conducted to the metal plate 1120 through the core metal layer 1132 and the heat conductor 1150 in the opening 1134 for dissipating heat. Other components of the backlight module 1100 are similar to those of the backlight module 400 in FIG. 5 and not described repeatedly.

As stated above, the backlight module of the present invention includes the heat conductor disposed between the light emitting device and the metal plate. For example, the metal plate is a back plate, a reflection plate or another metal plate. The metal plate can include a back plate, a reflection plate and another metal plate at the same time, and the heat conductor is disposed between the light emitting device and the metal plate. The heat conductor is preferably a metal block, an electrically insulating thermally conductive adhesive or another thermally conductive material. The present invention encompasses such modification depending on the demand and is not limited to the above embodiments.

FIG. 13 illustrates a liquid crystal display according to an embodiment of the present invention. The liquid crystal display 1200 includes a liquid crystal display panel 1210 and the backlight module 1220 disposed underthe panel 1210. The backlight module 1220 can be the backlight module in one of the above embodiments or another backlight module according to the present invention. Furthermore, the light exit surface of the optical plate (not shown in FIG. 13) in the backlight module 1220 faces the liquid crystal display panel 1210.

As stated above, in the liquid crystal display and the backlight module thereof of the present invention, heat generated by the light emitting device is conducted to the nearby metal plate through the heat conductor. Therefore, compared to the conventional ones, the liquid crystal display and the backlight module thereof of the present invention dissipate heat more efficiently. As a result, larger current can be used for driving the light emitting devices, and higher brightness is achieved with no heat dissipating problem. Furthermore, the problem that the luminescence efficiency is lowered when heat is not dissipated well is prevented. Meanwhile, because the brightness that the single light emitting device provides is increased, the number of the light emitting devices can be reduced. As a result, the manufacturing cost of the liquid crystal display and the backlight module thereof is lowered.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A backlight module comprising:
an optical plate having a light incident surface and a light exit surface;
a metal plate disposed near the light incident surface of the optical plate;
a plurality of light emitting devices disposed between the metal plate and the light incident surface;
a circuit board electrically connected with the light emitting devices; and
a heat conductor disposed between the light emitting devices and the metal plate for conducting heat generated by the light emitting devices to the metal plate.

2. The backlight module according to claim 1, wherein the light emitting devices comprise a plurality of pins, the heat conductor being made of an electrically insulating material, the heat conductor being disposed on, and in contact with, the pins, spanning the edge of the circuit board and contacting the metal plate.

3. The backlight module according to claim 1, wherein the circuit board comprises a hollow area, each light emitting device comprising a plurality of pins, the heat conductor being made of an electrically insulating material, the heat conductor being disposed in the hollow area and contacting the pins and the metal plate in the hollow area.

4. The backlight module according to claim 1, wherein the circuit board comprises a hollow area, each light emitting device comprising a chip, the heat conductor disposed in the hollow area and contacting the chip and the metal plate in the hollow area.

5. The backlight module according to claim 1 further comprising an electrically insulating, thermally conductive material, wherein the circuit board comprises a hollow area, each light emitting device comprising a chip and a plurality of pins near the chip, the heat conductor disposed in the hollow area and contacting the chip and the metal plate in the hollow area, the electrically insulating, thermally conductive material being disposed on, and in contact with, the pins, spanning the edge of the circuit board and contacting the metal plate.

6. The backlight module according to claim 1 further comprising an electrically insulating, thermally conductive material and a reflection plate, wherein the reflection plate is disposed near the light emitting devices, each light emitting device comprising a plurality of pins, the heat conductor being made of an electrically insulating material, the heat conductor being disposed between the pins and the reflection plate.

7. The backlight module according to claim 1 further comprising an electrically insulating, thermally conductive material and a reflection plate, wherein the circuit board comprises a hollow area, the reflection plate disposed near the light emitting devices, each light emitting device comprising a chip and a plurality of pins near the chip, the heat conductor disposed in the hollow area and contacting the chip and the metal plate in the hollow area, the electrically insulating, thermally conductive material being disposed between the pins and the reflection plate.

8. The backlight module according to claim 1, wherein the circuit board is a multi-layer board and comprises a core metal layer, an upper surface and a lower surface of the circuit board comprising an opening respectively, the openings exposing a portion of the core metal layer, the heat conductor disposed in the opening, heat generated by the light emitting device being conducted to the metal plate through the core metal layer and the heat conductor in the openings.

9. The backlight module according to claim 1, wherein the light emitting devices are arranged in a row and comprise a plurality of pins respectively, the pins being disposed on two sides of the row of light emitting devices.

10. The backlight module according to claim 1, wherein the light emitting devices are light emitting diodes.

11. The backlight module according to claim 1, wherein the metal plate is a back plate.

12. The backlight module according to claim 1, wherein the metal plate is a reflection plate.

13. The backlight module according to claim 6 further comprising a back plate, wherein the optical plate, the reflection plate, the circuit board, and the light emitting devices are disposed on the back plate.

14. The backlight module according to claim 1, wherein the heat conductor is an electrically insulating thermally conductive adhesive.

15. The backlight module according to claim 4, wherein the heat conductor is a metal block.

16. The backlight module according to claim 15 further comprising a heat sink compound disposed between the heat conductor and the chips.

17. The backlight module according to claim 1, wherein the light incident surface is perpendicular to the light exit surface.

18. The backlight module according to claim 1, wherein the light incident surface is parallel to the light exit surface.

19. The backlight module according to claim 1, wherein the light emitting devices are arranged in an array.

20. The backlight module according to claim 1, wherein the light emitting devices are arranged in a row and the heat conductor can be adhered or coated parallel to the light emitting devices arranged direction.

21. A liquid crystal display comprising:
a liquid crystal display panel;
a backlight module disposed under the liquid crystal display panel, the backlight module comprising:
an optical plate having a light incident surface and a light exit surface;
a metal plate disposed near the light incident surface of the optical plate;
a plurality of light emitting devices disposed between the metal plate and the light incident surface;
a circuit board electrically connected with the light emitting devices; and
a heat conductor disposed between the light emitting devices and the metal plate for conducting heat generated by the light emitting devices to the metal plate.

22. The liquid crystal display according to claim 21, wherein the light emitting devices comprise a plurality of pins, and the heat conductor is made of an electrically insulating material, the heat conductor being disposed on the pins, spanning the edge of the circuit board and contacting the metal plate.

23. The liquid crystal display according to claim 21, wherein the circuit board comprises a hollow area, and wherein each light emitting device comprising a plurality of pins, the heat conductor being made of an electrically insulating material, the heat conductor being disposed in the hollow area and contacting the pins and the metal plate in the hollow area.

24. The liquid crystal display according to claim 21, wherein the circuit board comprises at least a hollow area, each light emitting device comprising a chip, the heat conductor disposed in the hollow area and contacting both the chip and the metal plate in the hollow area.

25. The liquid crystal display according to claim 21, wherein the backlight module further comprises an electrically insulating thermally conductive material, wherein the circuit board comprises a hollow area, each light emitting device comprising a chip and a plurality of pins near the chip, the heat conductor being disposed in the hollow area and contacting both the chip and the metal plate in the hollow area, the electrically insulating thermally conductive material being disposed on the pins, spanning the edge of the circuit board and contacting the metal plate.

26. The liquid crystal display according to claim 21 further comprising an electrically insulating thermally conductive material and a reflection plate, wherein the reflection plate is disposed near the light emitting devices, each light emitting device comprising a plurality of pins, the heat conductor being made of an electrically insulating material, the heat conductor being disposed between the pins and the reflection plate.

27. The liquid crystal display according to claim 21, wherein the backlight module further comprises an electrically insulating thermally conductive material and a reflection plate, wherein the circuit board comprises a hollow area, the reflection plate being disposed near the light emitting devices, each light emitting device comprising a chip and a plurality of pins near the chip, the heat conductor being disposed in the hollow area and contacting both the chip and the metal plate in the hollow area, the electrically insulating thermally conductive material disposed between the pins and the reflection plate.

28. The liquid crystal display according to claim 21, wherein the circuit board is a multi-layer board and comprises a core metal layer, an upper surface and a lower surface of the circuit board comprising an opening respectively, the openings exposing a portion of the core metal plate, the heat conductor disposed in the opening, heat generated by the light emitting devices being conducted to the metal plate through the core metal layer and the heat conductor in the openings.

29. The liquid crystal display according to claim 21, wherein the light emitting devices are arranged in a row and comprise a plurality of pins respectively, the pins being disposed on two sides of the row of the light emitting devices.

30. The liquid crystal display according to claim 21, wherein the light emitting devices are light emitting diodes.

31. The liquid crystal display according to claim 21, wherein the metal plate is a back plate.

32. The liquid crystal display according to claim 21, wherein the metal plate is a reflection plate.

33. The liquid crystal display according to claim 26, wherein the backlight module further comprises a back plate, wherein the optical plate, the reflection plate, the circuit board and the light emitting devices are disposed on the back plate.

34. The liquid crystal display according to claim 21, wherein the heat conductor is an electrically insulating, thermally conductive adhesive.

35. The liquid crystal display according to claim 24, wherein the heat conductor is a metal block.

36. The liquid crystal display according to claim 35, wherein the backlight module further comprises a heat sink compound disposed between the heat conductor and the chips.

37. The liquid crystal display according to claim 21, wherein the light incident surface is perpendicular to the light exit surface.

38. The liquid crystal display according to claim 21, wherein the light incident surface is parallel to the light exit surface.

39. The liquid crystal display according to claim 21, wherein the light emitting devices are arranged in an array.

40. The liquid crystal display according to claim 21, wherein the light emitting devices are arranged in a row and the heat conductor can be adhered or coated parallel to the light emitting devices arranged direction.

41. A backlight module comprising:
a metal plate disposed near, but separated from, a light incident surface of an optical plate;
a plurality of light emitting devices disposed between the metal plate and the light incident surface;
a circuit board electrically connected with the light emitting devices; and
a thermally conducting, electrically insulating material extending between the light emitting devices and the metal plate.
